(19) United States
(12) Patent Application Publication
(10) Pub. No.: US 2016/0202896 A1
(43) Pub. Date: Jul. 14, 2016

(54) METHOD AND SYSTEM FOR RESIZING DIGITAL PAGE CONTENT

(71) Applicant: Kobo Incorporated, Toronto (CA)

(72) Inventor: Benjamin LANDAU, Toronto (CA)

(73) Assignee: KOBO INCORPORATED, Toronto (CA)

(21) Appl. No.: 14/593,359

(22) Filed: Jan. 9, 2015

(51) Int. Cl. G06F 3/0488; G06F 3/0483; G06F 17/21

(52) U.S. Cl. CPC G06F 3/04883; G06F 17/212; G06F 3/0483

(57) ABSTRACT

A method and system for resizing a digitally rendered page content for rendering on a display screen. The method comprises displaying a current page content of the e-book, the current page content bounded by at least one margin within the display screen, receiving a touch gesture enacted on the current page content, identifying the touch gesture as a command to modify the at least one margin, in response to the margin modify command, reconstructing the current page content by incorporating an adjacent page content portion of text characters while preserving a plurality of text attributes of the text characters, and within the display screen, rendering the reconstructed current page partially outside of the at least one margin.

### TECHNICAL FIELD

Examples described herein relate to a system and method for viewing digital content on a touchscreen display of a mobile computing device.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

As mobile computing devices having functionality for e-reading proliferate, users find it beneficial to be able to operate such devices in many varied surroundings to continue reading their favorite e-book, such as for example, at the beach, at poolside, and the like.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a mobile computing device for operation in resizing a viewable e-book page content portion, according to an embodiment.

FIG. 2 illustrates a schematic configuration of a mobile computing device configured for resizing a viewable e-book page content portion, according to an embodiment.

FIGS. 3a-3d illustrate example configurations for operating a mobile computing device for resizing viewable e-book content pages thereon, according to some embodiments.

FIG. 4 illustrates a method of operating a computing device for resizing viewable e-book content pages thereon, according to an embodiment.

### DETAILED DESCRIPTION

“E-books” are a form of electronic publication content stored in digital format in a computer non-transitory memory, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books via a pre-determined series of digitally constructed pages, which can be rendered on a display screen of a computing device in a manner intended to mimic a paginated printed publication. Still further, some devices (sometimes referred to as “e-readers”) can display digitally-stored content in a more reading-centric manner, while also providing, via a user input interface, the ability to manipulate that content for viewing in discrete successive pages corresponding to the pre-determined order of pages in a physical paper book as published.

An “e-reading device”, also referred to herein as an electronic personal display, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra=mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

### System and Hardware Description

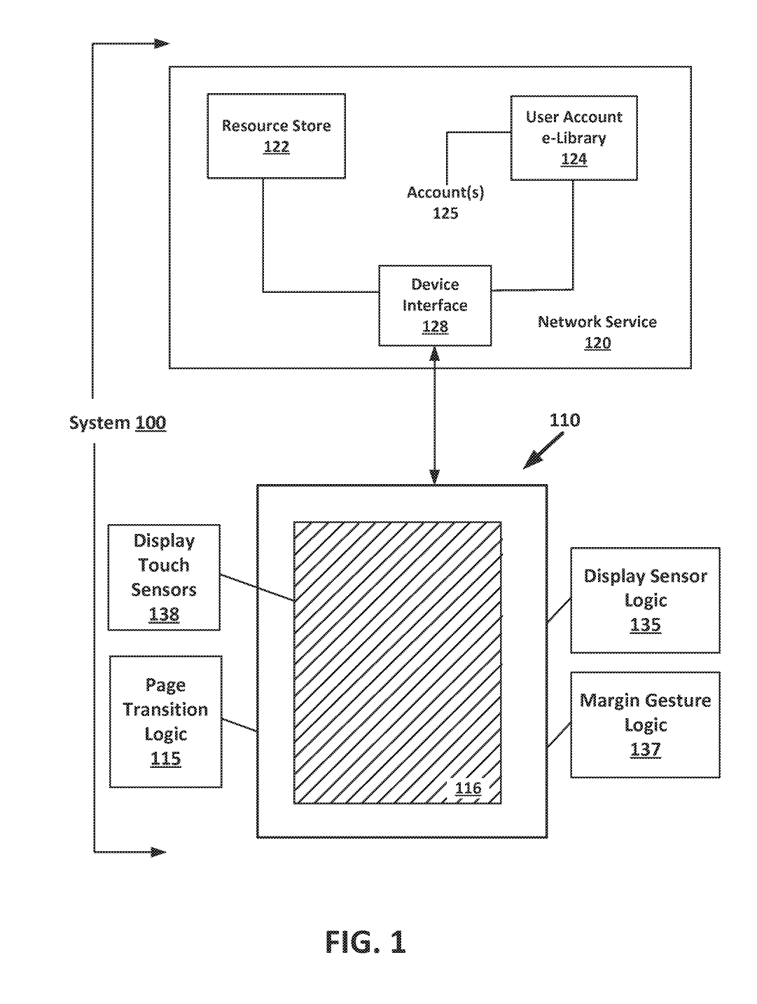

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services in communication with e-reading device 110. The e-book services provided through network service 120 can, for example, include services in which e-books are sold, shared, downloaded or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered for consumption. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an e-ink display.

In additional detail, the network service 120 can include a device interface 128, a resource store 122 and a user e-library 124. User e-library 124 can associate e-reading device 110 with a user and with account 125. Account 125 can also be associated with one or more application resources (e.g., e-books), which can be stored in the resource store 122, comprising an electronic library (c-library) of stored digital content. The device interface 128 can handle requests from the e-reading device 110, and further interface the requests of the device with services and functionality of the network service 120. The device interface 128 can utilize information provided with user account 125 in order to enable services, such as purchasing downloads of content or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, user e-library 124 can retain metadata for individual accounts 125 to identify resources or content that have been purchased or made available for consumption for a given account. The e-reading device 110 may be associated with the user account 125, and multiple devices may be associated with the same account. As described in greater detail below, the e-reading device 110 can store digital content items (e.g., e-books) that are purchased or otherwise made available to the user of the e-reading device 110, as well as to archive e-books and other digital content items that have been purchased for the user account 125, but are not stored on a particular computing device.

With reference to an example of FIG. 1, e-reading device 110 can include a display screen 116. In an embodiment, display screen 116 is touch-sensitive, to process touch inputs including gestures (e.g., swipes). For example, the display screen 116 may be integrated with one or more touch sensors 130 to provide a touch-sensing region on a surface of the display screen 116. For some embodiments, the one or more touch sensors 130 may include capacitive sensors that can sense or detect a human body's capacitance as input. In the example of FIG. 1, the touch-sensing region coincides with a substantial surface area, if not all, of the display screen 116. Yet further, an interaction received at the touch-sensing display screen 116 may coincide with the specific location of touch-sensors 130 involved thereon.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116.

According to some embodiments, the e-reading device 110 includes display sensor logic 135 to detect and interpret user input or user input commands made through interaction with the touch sensors 130. By way of example, the display sensor logic 135 can detect a user making contact with the touch-sensing region of the display screen 116. More specifically, the display sensor logic 135 can detect taps, an initial tap held in sustained contact or proximity with display screen 116 (otherwise known as a “long press”), multiple taps, and/or swiping gesture actions made through user interaction with the touch sensing region of the display screen 116. The swipe gesture action as used herein includes a progressive motion enacted upon touchscreen display 116 while maintaining continuous contact therewith. Furthermore, the display sensor logic 135 can interpret such interactions in a variety of ways. For example, each interaction may be interpreted as a particular type of user input corresponding with a change in state of the display 116.

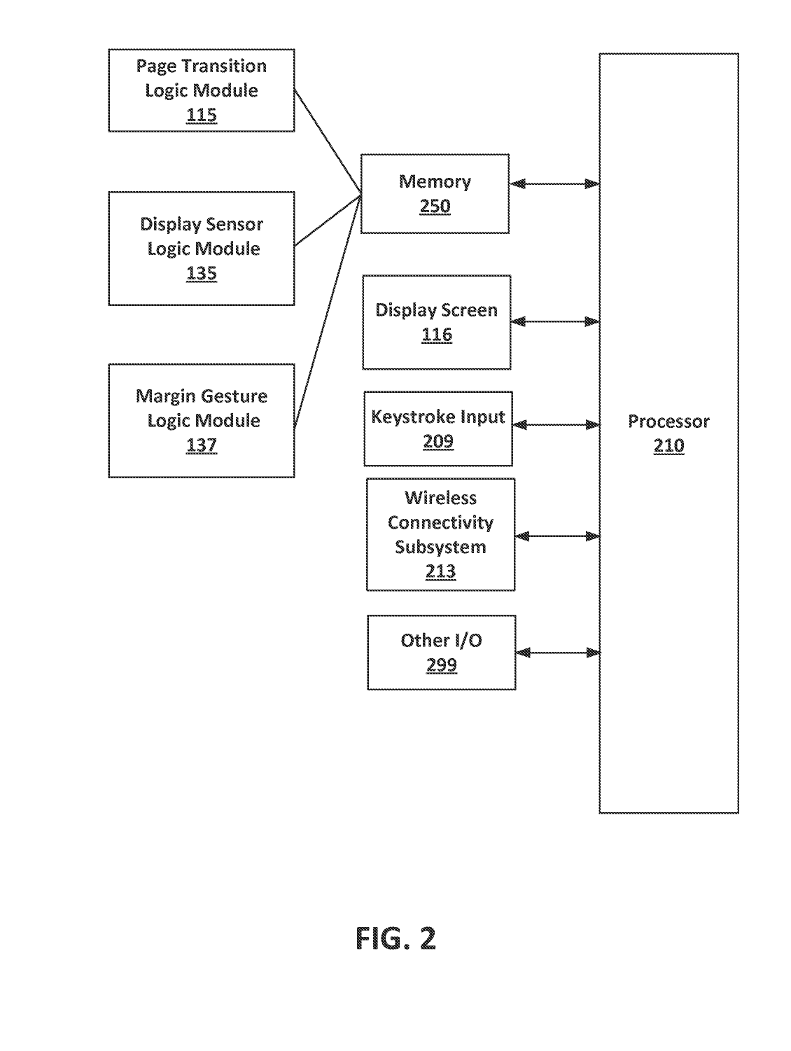

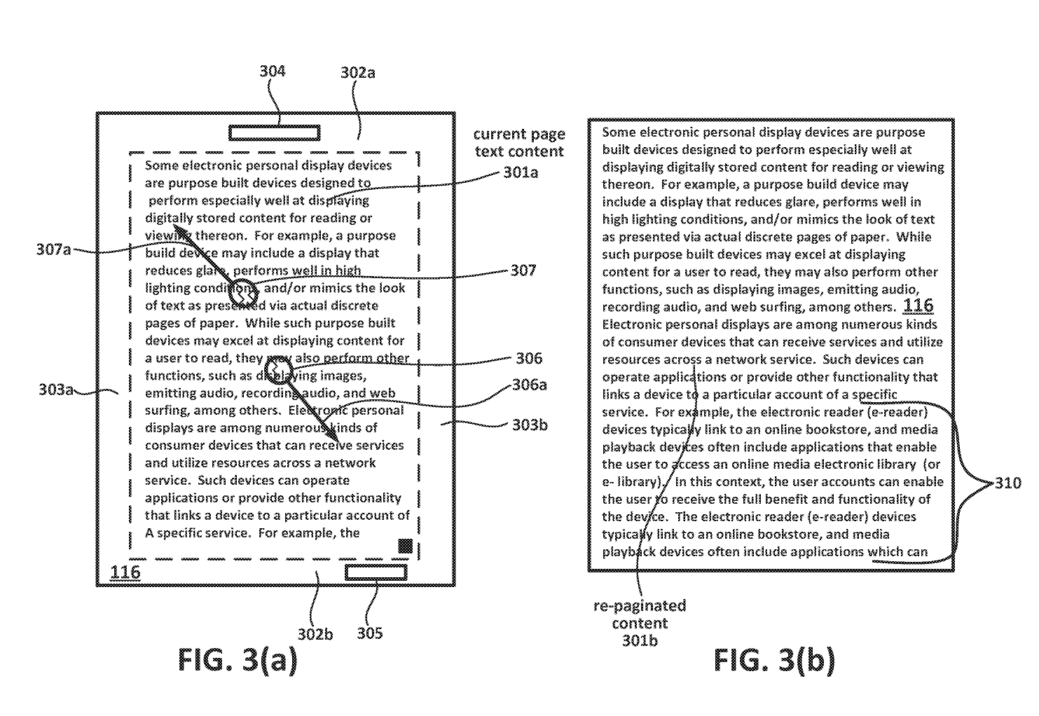

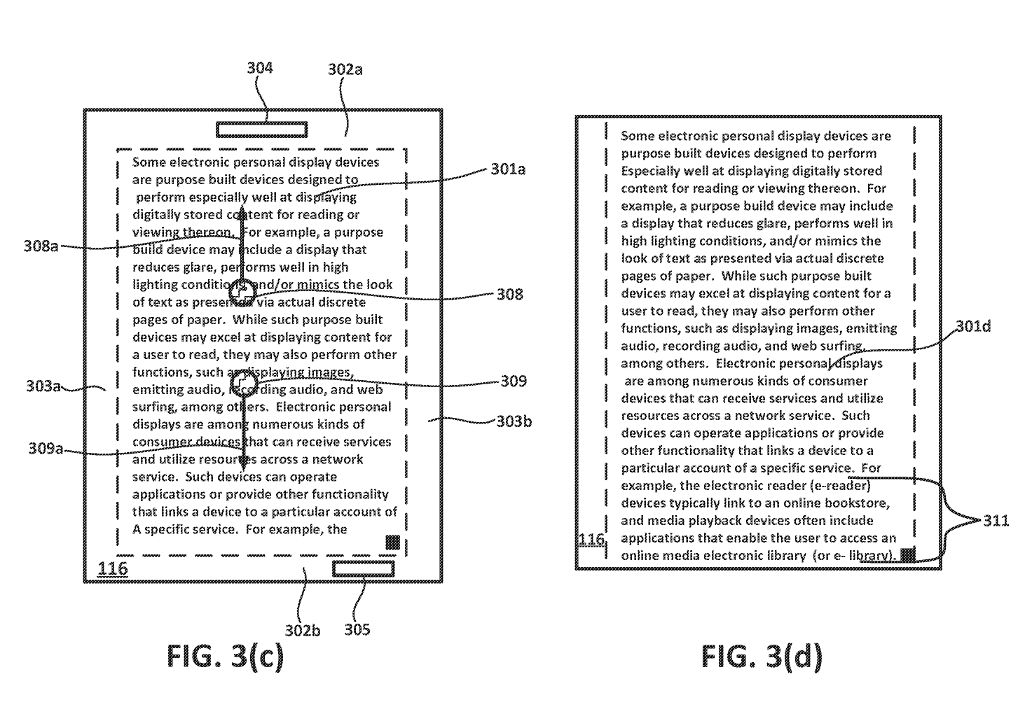

For some embodiments, e-reading device 110 further includes margin gesture logic module 137 for appropriately resizing, modifying or removing margins around text content of an e-book page being rendered for e-reading on display 116. For example, margin gesture logic 137 may be deployed for re-reconstructing or re-paginating the e-book page to display an increased portion of e-book content, as will be described further with reference to FIGS. 2 and 3. Accordingly, margin gesture logic 137 may be activated by the display sensor logic 135 upon detecting user input commands, deployed via touchscreen gesture actions upon display screen 116.

One or more embodiments of margin gesture logic 137 as described herein may be implemented by computing device 110 using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments of margin gesture logic 137 as described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

FIG. 2 illustrates a schematic architecture, in one embodiment, of e-reading device 110 as described above with respect to FIG. 1. With reference to FIG. 2, e-reading device 110 further includes a processor 210, a memory 250 storing instructions and logic pertaining at least to page transition logic 115, display sensor logic 135, and margin gesture logic 137.

Processor 210 can implement functionality using the logic and instructions stored in memory 250. Additionally, in some implementations, processor 210 communicates with the network service 120 (see FIG. 1). More specifically, e-reading device 110 can access the network service 120 to receive various kinds of resources (e.g., digital content items such as e-books, configuration files, account information), as well as to provide information (e.g., user account information, service requests etc.). For example, e-reading device 110 can receive application resources, such as e-books or media files, that the user elects to purchase or otherwise download via the network service 120. The application resources that are downloaded onto e-reading device 110 can be stored in memory 250.

In some implementations, display screen 116 can correspond to, for example, a liquid crystal display (LCD) or light emitting diode (LED) display that illuminates in order to provide content generated from processor 210. In some implementations, display screen 116 can be touch-sensitive. For example, in some embodiments, one or more of touch sensor components 138 may be integrated with display screen 116. In other embodiments, touch sensor components 138 may be provided (e.g., as a layer) above or below display screen 116 such that individual touch sensor components 138 track different regions of display screen 116. Further, in some variations, display screen 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display screen 116, keystroke input 209 such as from a virtual or rendered keyboard, and other input mechanisms 299 (e.g., buttons, mouse, microphone, etc.). With reference to examples described herein, processor 210 can respond to input detected at touch sensor components 138. In some embodiments, processor 210 responds to inputs from touch sensor components 138 in order to facilitate or enhance e-book activities such as generating e-book content on display screen 116, performing page transitions of the displayed e-book content, powering off e-reading device 110 and/or display screen 116, activating a screen saver, launching or closing an application, and/or otherwise altering a state of display screen 116.

In some embodiments, memory 250 may store display sensor logic 135 that monitors for user interactions detected through touch sensor components 138, and further processes the user interactions as a particular input or type of input. In an alternative embodiment, display sensor logic 135 may be integrated with touch sensor components 138. For example, touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which e-reading device 110 is intended to operate, such as in accordance with Wi-Fi, Bluetooth, Near Field Communication (NFC) communication protocols, and the like.

Margin gesture logic module 137, in conjunction with display sensor logic 135, may be deployed for appropriately resizing, modifying or removing margins around text content of an e-book page being rendered for e-reading on display 116. For example, margin gesture logic 137 may be deployed for re-reconstructing or re-paginating the e-book page to display an increased portion of e-book content. The term re-pagination as used herein is intended to encompass reconstructing content of a digitally rendered e-book page, including text content, of the digital content pages of an e-book while maintaining relative arrangements in the sequence of words and sentences to preserve readability across digitally structured and re-structured pages of the e-book. For example, such as by displacing text words or partial words within the content page while maintaining text attributes (e.g., font type, size and word and line spacing) for continuity in the e-reading experience. Accordingly, margin gesture logic 137 may be activated by the display sensor logic 135 upon detecting user input commands, deployed via touchscreen gesture actions upon display screen 116.

With reference now to FIG. 3a, illustrated is a current page content 301 within an e-book as digitally rendered within touchscreen display 116 of computing device 110. Current page content 301 may be bounded by top and bottom margins 302a, 302b and by left side and right side margins 303a. 303b, the margins thereby located at the extremes of current content page 301 within touchscreen display 116. In the generally rectangular embodiment of touchscreen display 116 depiction of FIG. 3a, top and bottom margins 302a, 302b may be orthogonally located relative to left side and right side margins 303a, 303b. Top and bottom margins 302a, 302b may respectively include book title 304 for the e-book being read and a page number 305 of the current content page 301a within the series of digitally constructed pages comprising the e-book. As illustrated, the e-book content pages, including current content page 301, include a pre-ordered sequence of text characters or words arranged in lines for organization in the series of digitally constructed pages. Typically, particular text and word attributes such as font type, font size, word spacing and line spacing, etc. may be applied with uniform consistency across the series of digital pages for continuity in the e-book reading experience.

Still with reference to FIG. 3a, illustrated in an embodiment is a dual-point 306, 307 swipe gesture action initiated generally at a central location within current page content 301, progressing in respective directions 306a, 307a respectively towards any or all of outer margins 302a, 302b and 303a, 303b. In an embodiment, the dual-point 306, 307 swipe gesture action may be identified via processor 250 of computing device 110 as a command to modify, such as to remove or minimize, any or all of margins 302a, 302b and 303a, 303b.

With reference now to FIG. 3b, in response to command to modify any or all of the margins 302a, 302b and 303a, 303b, illustrated is an embodiment whereby a greater portion of e-book content can now be displayed for viewing in a single screen, reconstructed version of current page content 301b within touchscreen display 116 of computing device 110. In the embodiment depicted, a content page portion 310 which previously resided within a next-in-series digital page subsequent or following current page content 301a, has now been incorporated in a repaginated or digitally reconstructed version of page content 301b, by line-wrapping lines and/or words of the subsequent page content portion thereinto. In another embodiment (not depicted), it is contemplated a similar portion of a previous page content portion may be incorporated into a leading position of a repaginated or digitally reconstructed version 301b of current page content 301a, similarly by line-wrapping lines and/or words of the previous page content portion thereinto. In the particular embodiment depicted in FIG. 3b, all of margins 302a, 302b and 303a, 303b including book title 304 and page number 305 of the current content page 301a are removed from display screen 116, allowing a greater portion of e-book content to be viewable in a single screen, per page rendering, which occupies a display screen portion outside of the previous margins 302a,b and 303a,b.

Still with reference to FIG. 3b, to ensure continuity in the e-reading experience, during the re-pagination or digital reconstruction of current page content, all text, word and sentence attributes such as font type, font size, word spacing and line spacing are preserved, such that no portions of content are magnified larger, smaller, etc., to maintain continuity in the reading experience for a given e-book.

Now with reference to FIG. 3c, depicted is an alternate embodiment in which a dual-point 308, 309 swipe gesture action initiated generally at a central location within current page content 301, progressing in directions 308a, 309a respectively towards top and bottom margins 302a, 302b respectively. In this embodiment, the dual-point 308, 309 swipe gesture action may be identified via processor 250 of computing device 110 as a command to modify, such as to remove or minimize, any or all of only top and bottom margins 302a, 302b.

With reference now to FIG. 3d, in response to command to modify any or all of only the top and bottom margins 302a, 302b, illustrated is an embodiment whereby a greater portion of e-book content can now be displayed for viewing in a single screen, reconstructed version 301d of current page content 301a, within touchscreen display 116 of computing device 110. In the embodiment depicted, a content page portion 311 which previously resided within a next-in-series digital page subsequent or following current page content 301a, has now been incorporated in a repaginated or digitally reconstructed version of page content 301d, by line-wrapping lines and/or words of the subsequent page content portion thereinto. Though not depicted, it is contemplated that, in similar manner, a dual-point swipe gesture may be applied at display screen 116 to modify, by removal or minimization, only left and right side margins of current page content 301a, using a swipe gesture action initiated generally at a central location within current page content 301, but progressing in directions respectively towards left and right margins 303a, 303b respectively.

### Methodology

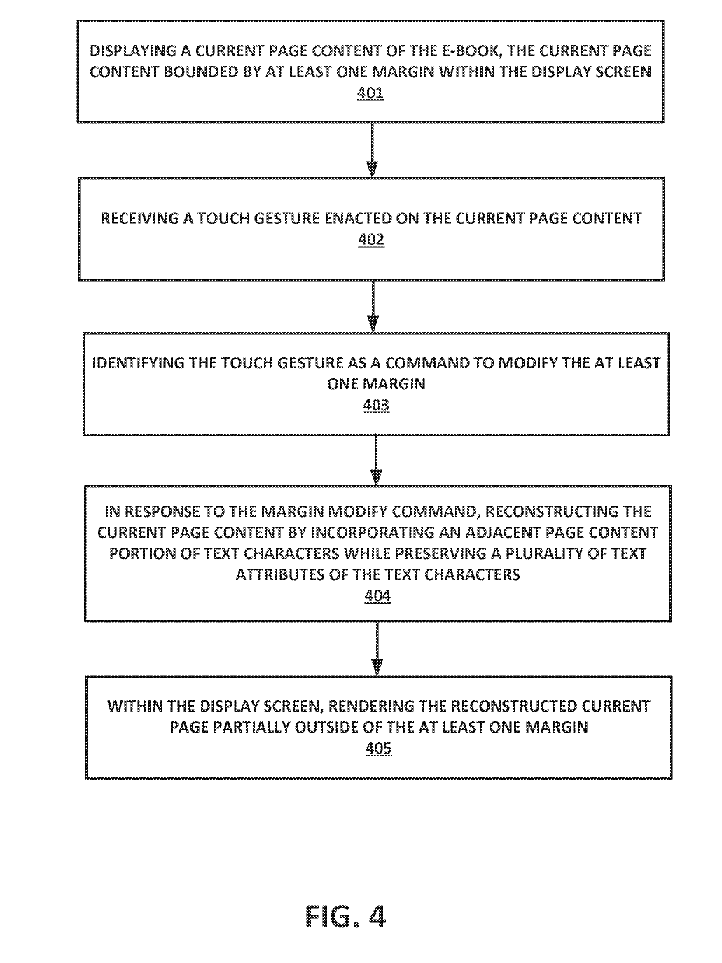

FIG. 4 illustrates a method of operating an e-reading device 110 to provide a margin removal or minimization option for content within a page of e-book content being displayed on the display 116, according to one or more embodiments. In describing the examples of FIG. 4, reference may be made to components such as described with FIGS. 1, 2 and 3a-3d, for purposes of illustrating suitable components and logic modules for performing a step or sub-step being described.

At step 401, displaying a current page content 301a of the e-book, the current page content bounded by at least one margin 302a, 302b, 303a, 303b within the display screen 116.

At step 402, receiving a touch gesture 306, 307, 308, 309 enacted on the current page content 301a on the display screen 116 at computing device 110.

At step 403, identifying the touch gesture 306, 307, 308, 309 as a command to modify the at least one margin 302a, 302b, 303a, 303b.

At step 404, in response to the margin modify command, reconstructing the current page content 301a by incorporating an adjacent page content portion of text characters while preserving a plurality of text attributes of the text characters.

At step 405, within the display screen 116, rendering the reconstructed current page 301b, 301d partially outside of the at least one margin 302a, 302b, 303a, 303b.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method executed in a processor of a computing device, the computing device having a memory storing instructions and an e-book, and a display screen including a set of touch sensors, the e-book including content having a pre-ordered sequence of text characters, the content organized in a series of digitally constructed pages, the method comprising:
displaying a current page content of the e-book, the current page content bounded by at least one margin within the display screen;
receiving a touch gesture enacted on the current page content;
identifying the touch gesture as a command to modify the at least one margin;
in response to the margin modify command, reconstructing the current page content by incorporating an adjacent page content portion of text characters while preserving a plurality of text attributes of the text characters; and
within the display screen, rendering the reconstructed current page partially outside of the at least one margin.

2. The method of claim 1 wherein the current page content is further bounded by a first pair of margins comprising a top and a bottom margin, the top and bottom margins being located at opposite extremes of the current page content, and a second pair of margins comprising a left side margin and a right side margin, the right and left margins being located at opposite extremes of the current page content.

3. The method of claim 2 wherein the first pair of margins are directed in orthogonal relationship to the second pair.

4. The method of claim 1 wherein the touch gesture comprises a multipoint swipe gesture enacted starting from a generally central location within the current content page and progressing towards the at least one margin.

5. The method of claim 1 wherein the margin modify command comprises a margin removal command.

6. The method of claim 1 wherein the margin modify command is a margin minimize command.

7. The method of claim 1 wherein the incorporated adjacent content page portion is one of a previous content page portion and a subsequent content page portion.

8. The method of claim 7 wherein the plurality of text attributes preserved in the reconstructed current page include at least one of: a font type, a font size a word spacing and a line spacing, as incorporated from the one of the previous content page portion and the subsequent content page portion.

9. The method of claim 1 wherein the current page content is further bounded by a top and a bottom margin, the top and bottom margins being located at opposite extremes of the current page content, and the touch gesture comprises a dual-point swipe gesture enacted from a generally central location within the current page content and progressing towards the top and bottom margins respectively, whereby the top and bottom margins are modified.

10. The method of claim 1 wherein the current page content is further bounded by left side margin and a right side margin, the right and left margins being located at opposite extremes of the current page content, and the touch gesture comprises a dual-point swipe gesture enacted from a generally central location within the current page content and progressing towards the right and left side margins respectively, whereby the right and left side margins are modified.

11. A computing device comprising:
a memory storing instructions and an e-book;
a display screen including a set of touch sensors;
a processor capable of inferring a presence of an extraneous object on the display screen based on an interaction with the set of touch sensors, the processor operable in conjunction with the instructions to:
display a current page content of the e-book, the current page content bounded by at least one margin within the display screen, the e-book including content having a pre-ordered sequence of text characters, the content organized in a series of digitally constructed pages;
receive a touch gesture enacted on the current page content;
identify the touch gesture as a command to modify the at least one margin;
in response to the margin modify command, reconstruct the current page content by incorporating an adjacent page content portion of text characters while preserving a plurality of text attributes of the text characters; and
within the display screen, render the reconstructed current page partially outside of the at least one margin.

12. The computing device of claim 11 wherein the current page content is further bounded by a first pair of margins comprising a top and a bottom margin, the top and bottom margins being located at opposite extremes of the current page content, and a second pair of margins comprising a left side margin and a right side margin, the right and left margins being located at opposite extremes of the current page content.

13. The computing device of claim 12 wherein the first pair of margins are directed in orthogonal relationship to the second pair.

14. The computing device of claim 11 wherein the touch gesture comprises a multipoint swipe gesture enacted starting from a generally central location within the current content page and progressing towards the at least one margin.

15. The computing device of claim 11 wherein the margin modify command is one of a margin removal and a margin minimize command.

16. The computing device of claim 11 wherein the incorporated adjacent content page portion is one of a previous content page portion and a subsequent content page portion.

17. The computing device of claim 16 wherein the plurality of text attributes preserved in the reconstructed current page include at least one of: a font type, a font size a word spacing and a line spacing, as incorporated from the one of the previous content page portion and the subsequent content page portion.

18. The computing device of claim 11 wherein the ending text portion of the e-book content page maintains at least one of: a font type, a font size and a word spacing when wrapped into the next page of the e-book content.

19. The computing device of claim 11 wherein the current page content is further bounded by a top and a bottom margin, the top and bottom margins being located at opposite extremes of the current page content, and the touch gesture comprises a dual-point swipe gesture enacted from a generally central location within the current page content and progressing towards the top and bottom margins respectively, whereby the top and bottom margins are modified.

20. A non-transitory computer-readable medium storing instructions that, when executed by a processor of a computing device, cause the processor to perform operations that include:
displaying a current page content of an e-book, the current page content bounded by at least one margin within the display screen, the e-book including content having a pre-ordered sequence of text characters, the content organized in a series of digitally constructed pages;
receiving a touch gesture enacted on the current page content;
identifying the touch gesture as a command to modify the at least one margin;
in response to the margin modify command, reconstructing the current page content by incorporating an adjacent page content portion of text characters while preserving a plurality of text attributes of the text characters; and
within the display screen, rendering the reconstructed current page partially outside of the at least one margin.
